(19) United States
(12) Patent Application Publication
(10) Pub. No.: US 2021/0028815 A1
(43) Pub. Date: Jan. 28, 2021

(54) PHYSICAL UPLINK SHARED CHANNEL (PUSCH) FREQUENCY HOPPING ALLOCATION

(71) Applicant: Telefonaktiebolaget LM Ericsson (publ), Stockholm (SE)

(72) Inventors: Robert BALDEMAIR, Solna (SE); Daniel CHEN LARSSON, Lund (SE); Erik DAHLMAN, Stockholm (SE); Sorour FALAHATI, Stockholm (SE); Stefan PARKVALL, Bromma (SE)

(21) Appl. No.: 16/969,019

(22) PCT Filed: Feb. 18, 2019
(86) PCT No.: PCT/SE2019/050143

§ 371 Date: Aug. 11, 2020

(30) Foreign Application Priority Data
Feb. 16, 2018 (SE) 1800041-4

(51) Int. Cl. H04B 1/7143; H04W 72/04

(52) U.S. Cl. CPC H04B 1/7143; H04W 72/0446

(57) ABSTRACT

A method and apparatus are disclosed. A wireless device (WD) configured to communicate with a network node is provided. The WD includes a radio interface and processing circuitry configured to: if a configured frequency hopping distance results in a resource allocation at two edges of a slot, apply a modified resource allocation that avoids resource allocation at two bandwidth part, BWP, edges. The modified resource allocation corresponds to a frequency hopping distance different from the configured frequency hopping distance. The radio interface and/or processing circuitry is further configured to transmit using the modified resource allocation.

### TECHNICAL FIELD

Wireless communication and in particular, to uplink frequency hopping allocation in wireless communications.

### BACKGROUND

Frequency-Hopping in Long Term Evolution (LTE)

LTE defines at least two types of uplink (UL) frequency-hopping. As used herein, UL refers to communications from the wireless device (WD) to the network node, e.g., base station.

In the first case (or first type of UL frequency hopping), the UL system bandwidth is portioned into sub-bands. The wireless devices may receive an allocation of Virtual Resource Blocks (VRB) in the UL grant which are then mapped according to a cell-specific hopping sequence to Physical Resource Blocks (PRB). The mapping occurs from one sub-band into another sub-band. An LTE subframe consists of two slots, and the mapping is different between for the first and second slot. FIG. 1 is a diagram of an example frequency hopping according to a cell-specific hopping pattern.

In the second type of UL frequency hopping (or second case), information in the UL grant controls the amount of how much the frequency-domain resource allocation hops between first and second slot. For narrow system bandwidth, the hop may be ½ of a predefined maximum hopping distance. For larger system bandwidths, the hopping distance can be −¼, ¼, and ½ of predefined maximum hopping distance. FIG. 2 is a diagram of frequency hopping based on hopping distance in the UL grant.

For both hopping cases, the jump is cyclic, i.e., a jump/hop leaving the resource grid on one end enters the resource grid from the other side.

Frequency-Hopping in NR

For NR frequency-hopping, the following may be provided:

The starting RB during in each hop may be given by:

$${RB}_{start} = \{ \begin{matrix}{RB}_{start} & Firsthop \\ ( {RB}_{start} + {RB}_{offset} ) mod {N}_{BWP}^{size} & Secondhop\end{matrix}$$

with RBₛₜₐᵣₜ referring to the RB given in the grant and RB_{offset} referring to the applied offset value. Depending on the bandwidth part (BWP) bandwidth, 2 or 4 offset values can be configured and 1 or 2 bits in the downlink control information (DCI) may be used to select one of the configured values. Whether the frequency-hopping should be applied may be configured by radio resource control (RRC).

### SUMMARY

Some embodiments advantageously provide methods, systems, and apparatuses for uplink frequency hopping allocation in wireless communications.

The disclosure describes different solutions for helping avoid a frequency-hopped resource allocation that partly wraps around at BWP edge. In cases where the waveform has a low peak to average power ratio (PAPR) (as in DFTS-OFDM), low PAPR is maintained for the frequency-hopped allocation by applying one or more solutions described herein. Therefore, the disclosure helps avoid partly wrapped around resource allocations, thereby helping avoid “island” resource allocation leading to potentially high power backoff.

According to one aspect of the disclosure, a network node configured to communicate with a wireless device (WD) is provided. The network node is configured to, and/or comprising a radio interface and/or comprising processing circuitry configured to: configure a wireless device with a first frequency hopping distance that results in a resource allocation at two edges of a slot, and receive transmission corresponding to a modified resource allocation that avoids the resource allocation at two edges of the slot. The modified resource allocation corresponds to a second frequency hopping distance different from the first frequency hopping distance.

According to one embodiment of this aspect, the modified resource allocation: corresponds to a frequency hopping distance that is one of shorter and longer than the configured frequency hopping distance, or corresponds to a resource allocation at one edge of the slot. According to one embodiment of this aspect, the modified resource allocation corresponds to: a resource allocation of another slot preceding the slot, a mirroring of the resource allocation of another slot preceding the slot, or a frequency hopping distance that is equal to a negative value of the configured frequency hopping distance.

According to one aspect of the disclosure, a method implemented in a network node is provided. A wireless device is configured with a first frequency hopping distance that results in a resource allocation at two edges of a slot. Transmission corresponding to a modified resource allocation that avoids the resource allocation at two edges of the slot is received where the modified resource allocation corresponding to a second frequency hopping distance different from the first frequency hopping distance.

According to one embodiment of this aspect, the modified resource allocation: corresponds to a frequency hopping distance that is one of shorter and longer than the configured frequency hopping distance, or corresponds to a resource allocation at one edge of the slot. According to one embodiment of this aspect, the modified resource allocation corresponds to: a resource allocation of another slot preceding the slot, a mirroring of the resource allocation of another slot preceding the slot, or a frequency hopping distance that is equal to a negative value of the configured frequency hopping distance.

According to one aspect of the disclosure, a wireless device (WD) configured to communicate with a network node is provided. The WD configured to, and/or including a radio interface and/or processing circuitry configured to: if a configured frequency hopping distance results in a resource allocation at two edges of a slot, apply a modified resource allocation that avoids resource allocation at two edges of the slot where the modified resource allocation corresponds to a frequency hopping distance different from the configured frequency hopping distance, and transmit using the modified resource allocation.

According to one embodiment of this aspect, the modified resource allocation: corresponds to a frequency hopping distance that is one of shorter and longer than the configured frequency hopping distance, or corresponds to a resource allocation at one edge of the slot. According to one embodiment of this aspect, the modified resource allocation corresponds to: a resource allocation of another slot preceding the slot, a mirroring of the resource allocation of another slot preceding the slot, or a frequency hopping distance that is equal to a negative value of the configured frequency hopping distance.

According to one aspect of the disclosure, a method implemented in a wireless device (WD) is provided. If a configured frequency hopping distance results in a resource allocation at two edges of a slot, a modified resource allocation that avoids resource allocation at two edges of the slot is applied where the modified resource allocation corresponds to a frequency hopping distance different from the configured frequency hopping distance. The modified resource allocation is used for transmission.

According to one embodiment of this aspect, the modified resource allocation: corresponds to a frequency hopping distance that is one of shorter and longer than the configured frequency hopping distance, or corresponds to a resource allocation at one edge of the slot. According to one embodiment of this aspect, the modified resource allocation corresponds to: a resource allocation of a preceding slot, a mirroring of the resource allocation of the preceding slot, or a frequency hopping distance that is equal to a negative value of the configured frequency hopping distance.

According to one aspect of the disclosure, a network node is provided. The network node includes a configuration module configured to configure a wireless device with a first frequency hopping distance that results in a resource allocation at two edges of a slot, and a receiving module configured to receive transmission corresponding to a modified resource allocation that avoids the resource allocation at two edges of the slot where the modified resource allocation corresponding to a second frequency hopping distance different from the first frequency hopping distance.

According to one aspect of the disclosure, a wireless device is provided. The wireless device includes a modification module configured to if a configured frequency hopping distance results in a resource allocation at two edges of a slot, apply a modified resource allocation that avoids resource allocation at two edges of the slot where the modified resource allocation corresponding to a frequency hopping distance different from the configured frequency hopping distance, and a transmission module configured to transmit using the modified resource allocation.

According to one aspect of the disclosure, a host computer is provided. The host computer includes a communication module configured to communicate information associated with one or more frequency hopping distances.

According to another aspect of the disclosure, a wireless device, WD, configured to communicate with a network node is provided. The WD comprises a radio interface and processing circuitry configured to, if a configured frequency hopping distance results in a resource allocation at two bandwidth part, BWP, edges, apply a modified resource allocation that avoids resource allocation at two BWP edges, the modified resource allocation corresponding to a frequency hopping distance different from the configured frequency hopping distance; and transmit using the modified resource allocation.

According to some embodiments of this aspect, the two BWP edges are two BWP edges of a slot. According to some embodiments of this aspect, the resource allocation at the two BWP edges corresponds to a partial wrap around of resources. According to some embodiments of this aspect, the modified resource allocation corresponds to at least one of: a frequency hopping distance that is one of shorter and longer than the configured frequency hopping distance; and a resource allocation at one BWP edge of the two BWP edges. According to some embodiments of this aspect, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured frequency hopping distance. According to some embodiments of this aspect, the modified resource allocation corresponds to a discontinuous transmission. According to some embodiments of this aspect, the processing circuitry is configured to one of apply the modified resource allocation and apply the configured frequency hopping distance based on a type of waveform.

According to another aspect of the disclosure, a method implemented in a wireless device (WD) is provided. The method comprises, if a configured frequency hopping distance results in a resource allocation at two bandwidth part, BWP, edges, applying a modified resource allocation that avoids resource allocation at two BWP edges, the modified resource allocation corresponding to a frequency hopping distance different from the configured frequency hopping distance. The method comprises transmitting using the modified resource allocation.

According to some embodiments of this aspect, the two BWP edges are two BWP edges of a slot. According to some embodiments of this aspect, the resource allocation at the two BWP edges corresponds to a partial wrap around of resources. According to some embodiments of this aspect, the modified resource allocation corresponds to at least one of: a frequency hopping distance that is one of shorter and longer than the configured frequency hopping distance; and a resource allocation at one BWP edge of the two BWP edges. According to some embodiments of this aspect, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured frequency hopping distance. According to some embodiments of this aspect, the modified resource allocation corresponds to a discontinuous transmission. According to some embodiments of this aspect, the method further comprises one of applying the modified resource allocation and applying the configured frequency hopping distance based on a type of waveform.

According to another aspect of the disclosure, a network node is provided. The network node comprises a radio interface and processing circuitry configured to: configure a wireless device, WD, with a first frequency hopping distance that results in a resource allocation at two bandwidth part, BWP, edges; and receive a transmission corresponding to a modified resource allocation that avoids the resource allocation at the two BWP edges, the modified resource allocation corresponding to a second frequency hopping distance different from the first frequency hopping distance.

According to some embodiments of this aspect, the two BWP edges are BWP edges of a slot. According to some embodiments of this aspect, the resource allocation at the two BWP edges corresponds to a partial wrap around of resources. According to some embodiments of this aspect, the modified resource allocation corresponds to at least at least one of: a frequency hopping distance that is one of shorter and longer than the configured first frequency hopping distance; and a resource allocation at one BWP edge of the two BWP edges. According to some embodiments of this aspect, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured first frequency hopping distance. According to some embodiments of this aspect, the modified resource allocation corresponds to a discontinuous transmission.

According to yet another aspect of the disclosure, a method implemented in a network node is provided. The method comprises configuring a wireless device, WD, with a first frequency hopping distance that results in a resource allocation at two bandwidth part, BWP, edges. The method comprises receiving a transmission corresponding to a modified resource allocation that avoids the resource allocation at the two BWP edges, the modified resource allocation corresponding to a second frequency hopping distance different from the first frequency hopping distance.

According to some embodiments of this aspect, the two BWP edges are BWP edges of a slot. According to some embodiments of this aspect, the resource allocation at the two BWP edges corresponds to a partial wrap around of resources. According to some embodiments of this aspect, the modified resource allocation corresponds to at least at least one of: a frequency hopping distance that is one of shorter and longer than the configured first frequency hopping distance; and a resource allocation at one BWP edge of the two BWP edges. According to some embodiments of this aspect, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured first frequency hopping distance. According to some embodiments of this aspect, the modified resource allocation corresponds to a discontinuous transmission.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example frequency hopping according to a cell-specific hopping pattern;

FIG. 2 is a diagram of frequency hopping based on hopping distance in the UL grant;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a block diagram of an alternative embodiment of a host computer according to some embodiments of the present disclosure;

FIG. 6 is a block diagram of an alternative embodiment of a network node according to some embodiments of the present disclosure;

FIG. 7 is a block diagram of an alternative embodiment of a wireless device according to some embodiments of the present disclosure;

FIG. 8 is a flow chart illustrating exemplary methods implemented in a communication system including a host computer, a network node and a wireless device for executing a client application at a wireless device according to some embodiments of the present disclosure;

FIG. 9 is a flow chart illustrating exemplary methods implemented in a communication system including a host computer, a network node and a wireless device for receiving user data at a wireless device according to some embodiments of the present disclosure;

FIG. 10 is a flow chart illustrating exemplary methods implemented in a communication system including a host computer, a network node and a wireless device for receiving user data from the wireless device at a host computer according to some embodiments of the present disclosure;

FIG. 11 is a flow chart illustrating exemplary methods implemented in a communication system including a host computer, a network node and a wireless device for receiving user data at a host computer according to some embodiments of the present disclosure;

FIG. 12 is a flowchart of an exemplary process in a network node for configuring a wireless device according to some embodiments of the present disclosure;

FIG. 13 is a flowchart of an exemplary process in a wireless device for modifying a resource allocation according to some embodiments of the present disclosure;

FIG. 14 is a diagram illustrating how the hopping distance is modified according to some embodiments of the present disclosure;

FIG. 15 is a diagram of different examples of resource allocations without wrap around, and resource allocations with wrap around according to some embodiments of the present disclosure;

FIG. 16 is an example of a mirror process according to some embodiments of the present disclosure; and

FIG. 17 is an example of a sign reversal process according to some embodiments of the present disclosure.

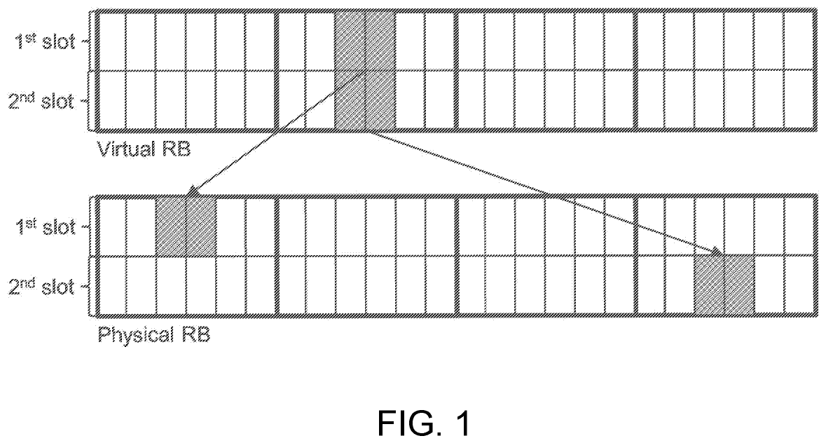

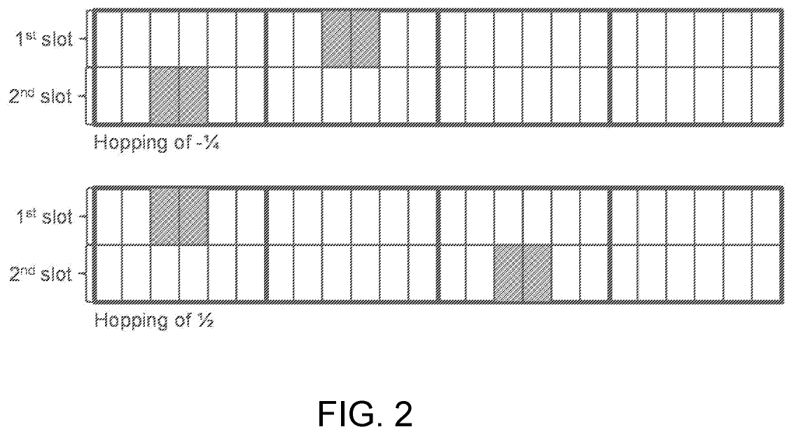

### DETAILED DESCRIPTION

Existing systems fail to prevent frequency-hopped resource allocation that partly wraps around, i.e., some parts of the allocation stay on one edge of the BWP while the other part wraps around to the other edge of the BWP. This breaks the resource allocation into two portions/islands at the lower and upper BWP edge. Partly wrapped around resources may lead to higher peak-to-average power ratio (PAPR) (if the waveform is Discrete Fourier Transform Spread-Orthogonal Frequency-Division Multiplexing (DFTS-OFDM)) but can also lead to intermodulation products that may require large power backoff (e.g., a reduction in power such as transmission power).

The disclosure describes different solutions/embodiments for helping avoid a frequency-hopped resource allocation that partly wraps around at BWP edge. Solutions/embodiments are presented to avoid the frequency-hopped resource allocation being partly wrapped around a BWP, i.e., some parts of the resources would be at a lower edge of the BWP while some parts of the resources would be at the upper edge of the BWP.

In case the waveform is low PAPR (DFTS-OFDM), low PAPR is maintained for the frequency-hopped allocation by applying one or more solutions described herein. Therefore, the disclosure helps avoid partly wrapped around resource allocations, thereby helping avoid “island” resource allocation leading to potentially high power backoff.

Before describing in detail exemplary embodiments, it is noted that the embodiments reside primarily in combinations of apparatus components and processing steps related to uplink frequency hopping allocation in wireless communications. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, integrated access and backhaul, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Generally, configuring may include determining configuration data representing the configuration and providing, e.g. transmitting, it to one or more other nodes (parallel and/or sequentially), which may transmit it further to the radio node (or another node, which may be repeated until it reaches the wireless device 22). Alternatively, or additionally, configuring a radio node, e.g., by a network node 16 or other device, may include receiving configuration data and/or data pertaining to configuration data, e.g., from another node like a network node 16, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD 22) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD 22) may comprise configuring the WD 22 to providing uplink grant or scheduling to WD 22 indicating a virtual resource block (VRB) allocation or a frequency hop.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information.

It should be understood that, in some embodiments, signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that it represents signaling and/or information for that channel, and/or that the signaling is interpreted by the transmitter and/or receiver to belong to that channel. Such signaling may generally comply with transmission parameters and/or format/s for the channel.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide uplink frequency hopping allocation in wireless communications. In one example, a modified resource allocation is applied in order to help avoid resource allocation at partly wrapped resources resource allocation at two edges of the slot, where the modified resources correspond to change in the frequency hopping distance. These embodiments are further described herein.

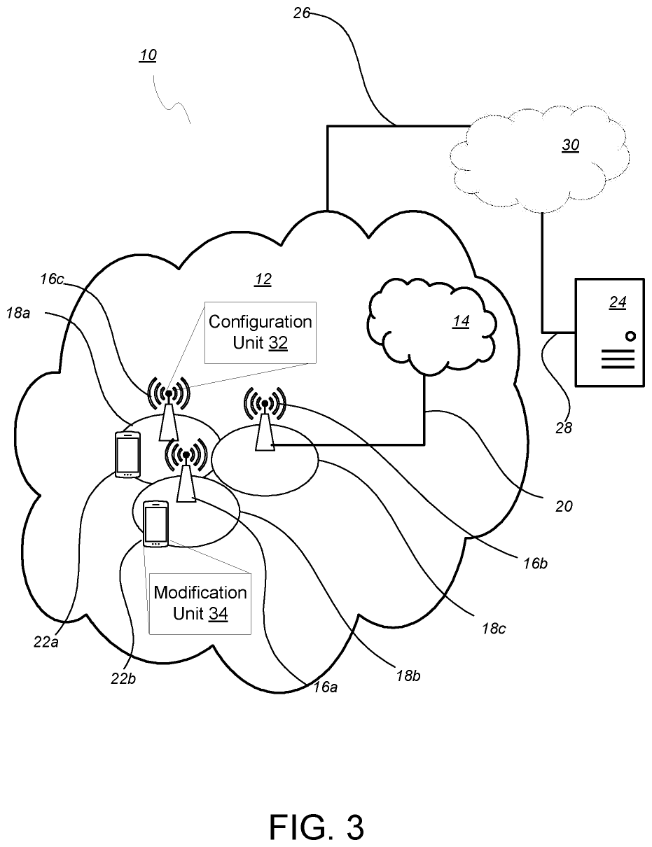

Returning to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WS 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure a wireless device, WD 22, with a first frequency hopping distance that results in a resource allocation at two bandwidth part, BWP, edges. The network node 16 may be configured to receive a transmission corresponding to a modified resource allocation that avoids the resource allocation at the two BWP edges, the modified resource allocation corresponding to a second frequency hopping distance different from the first frequency hopping distance. In another embodiment, the configuration unit 32 is configured to configure a wireless device with a first frequency hopping distance that results in a resource allocation at two edges of a slot, where, in one embodiment, the WD 22 applies a modified resource allocation to avoid this resource allocation at the two edges of the slot.

A wireless device 22 is configured to include a modification unit 34 which is configured to, if a configured frequency hopping distance results in a resource allocation at two bandwidth part, BWP, edges, apply a modified resource allocation that avoids resource allocation at two BWP edges, the modified resource allocation corresponding to a frequency hopping distance different from the configured frequency hopping distance. The wireless device 22 may be configured to transmit using the modified resource allocation. In another embodiment, the modification unit 34 is configured to, if a configured frequency hopping distance results in a resource allocation at two edges of a slot, apply a modified resource allocation that avoids resource allocation at two edges of the slot. In one embodiment, the modified resource allocation corresponds to a frequency hopping distance different from the configured frequency hopping distance.

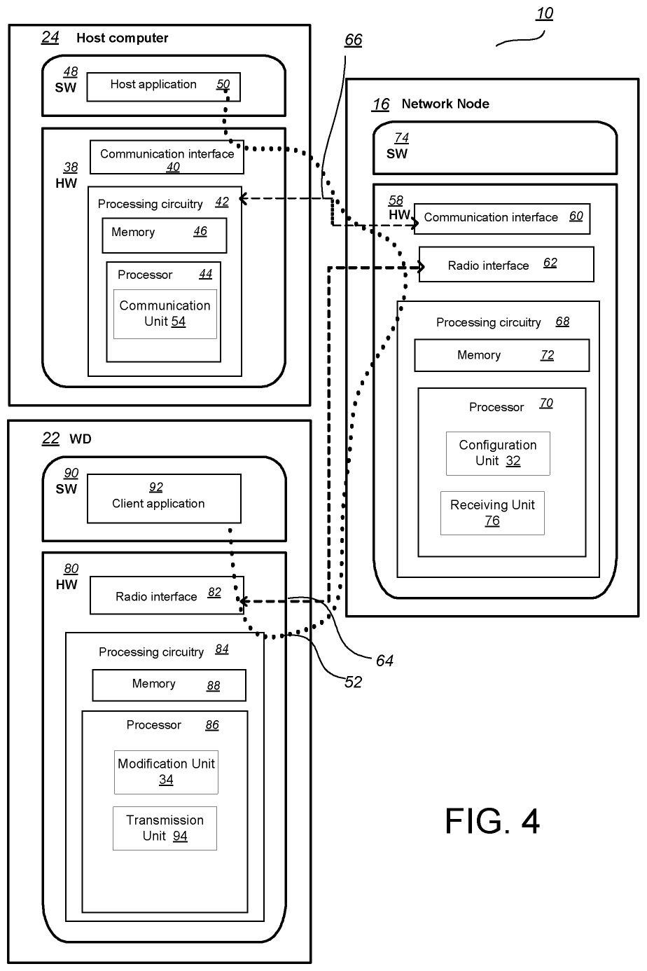

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a communication unit 54 configured to enable the service provider to communicate information associated with one or more frequency hopping distances.

The communication system 10 further includes a network node 16 provided in a communication system 10 and comprising hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to configure a wireless device, WD 22, with a first frequency hopping distance that results in a resource allocation at two bandwidth part, BWP, edges. The network node 16 may include a receiving unit 76 configured to receive (and/or cause reception of) a transmission corresponding to a modified resource allocation that avoids the resource allocation at the two BWP edges, the modified resource allocation corresponding to a second frequency hopping distance different from the first frequency hopping distance.

In some embodiments, the two BWP edges are BWP edges of a slot. In some embodiments, the resource allocation at the two BWP edges corresponds to a partial wrap around of resources. In some embodiments, the modified resource allocation corresponds to at least at least one of: a frequency hopping distance that is one of shorter and longer than the configured first frequency hopping distance; and a resource allocation at one BWP edge of the two BWP edges. In some embodiments, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured first frequency hopping distance. In some embodiments, the modified resource allocation corresponds to a discontinuous transmission.

In another embodiment, configuration unit 32 may be configured to configure a wireless device with a first frequency hopping distance that results in a resource allocation at two edges of a slot. The processing circuitry 68 may also include receiving unit 76 configured to receive transmission corresponding to a modified resource allocation that avoids the resource allocation at two edges of the slot, the modified resource allocation corresponding to a second frequency hopping distance different from the first frequency hopping distance.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a modification unit 34 configured to, if a configured frequency hopping distance results in a resource allocation at two bandwidth part, BWP, edges, apply a modified resource allocation that avoids resource allocation at two BWP edges, the modified resource allocation corresponding to a frequency hopping distance different from the configured frequency hopping distance. The WD 22 may include a transmission unit 94 configured to transmit (and/or cause a transmission) using the modified resource allocation.

In some embodiments, the two BWP edges are two BWP edges of a slot. In some embodiments, the resource allocation at the two BWP edges corresponds to a partial wrap around of resources. In some embodiments, the modified resource allocation corresponds to at least one of: a frequency hopping distance that is one of shorter and longer than the configured frequency hopping distance; and a resource allocation at one BWP edge of the two BWP edges. In some embodiments, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured frequency hopping distance. In some embodiments, the modified resource allocation corresponds to a discontinuous transmission. In some embodiments, the processing circuitry 84 is configured to one of apply the modified resource allocation and apply the configured frequency hopping distance based on a type of waveform.

In another embodiment, modification unit 34 is configured to, if a configured frequency hopping distance results in a resource allocation at two edges of a slot, apply a modified resource allocation that avoids resource allocation at two edges of the slot. In one or more embodiments, the modified resource allocation corresponds to a frequency hopping distance different from the configured frequency hopping distance. The processing circuitry 84 may also include transmission unit 94 configured to transmit using the modified resource allocation.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as configuration unit 32, modification unit 34, communication unit 54, receiving unit 76 and transmission unit 94 as being within a respective processor, it is contemplated that these units may be implemented such that a portion of the unit is stored in a corresponding memory within the processing circuitry. In other words, the units may be implemented in hardware or in a combination of hardware and software within the processing circuitry.

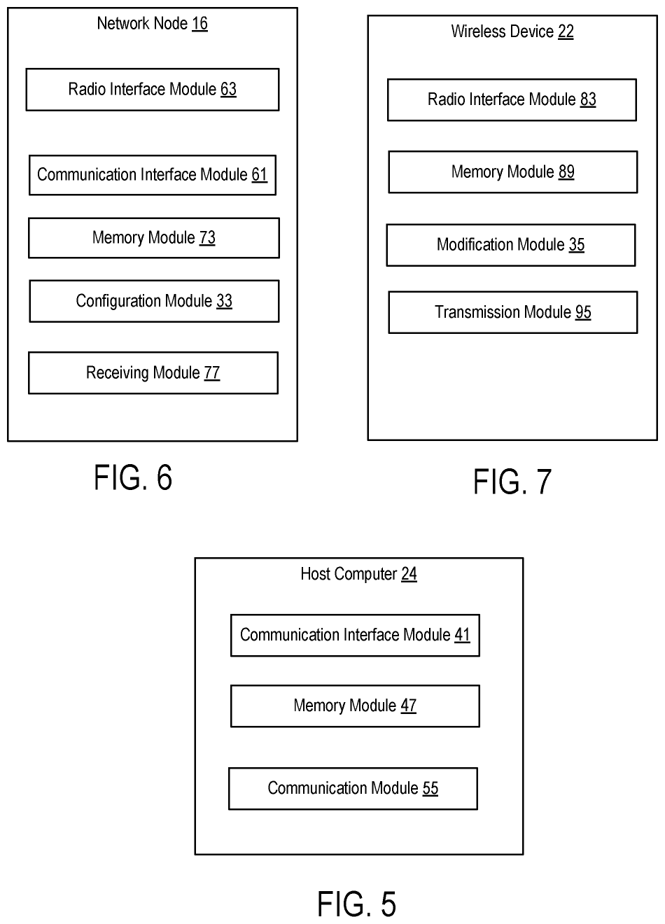

FIG. 5 is a block diagram of an alternative host computer 24, which may be implemented at least in part by software modules containing software executable by a processor to perform the functions described herein. The host computer 24 include a communication interface module 41 configured to set up and maintain a wired or wireless connection with an interface of a different communication device of the communication system 10. The memory module 47 is configured to store data, programmatic software code and/or other information described herein. Communication module 55 is configured to enable the service provider to communicate information associated with one or more frequency hopping distances.

FIG. 6 is a block diagram of an alternative network node 16, which may be implemented at least in part by software modules containing software executable by a processor to perform the functions described herein. The network node 16 includes a radio interface module 63 configured for setting up and maintaining at least a wireless connection 64 with a WD 22 located in a coverage area 18 served by the network node 16. The network node 16 also includes a communication interface module 61 configured for setting up and maintaining a wired or wireless connection with an interface of a different communication device of the communication system 10. The communication interface module 61 may also be configured to facilitate a connection 66 to the host computer 24. The memory module 73 that is configured to store data, programmatic software code and/or other information described herein. The configuration module 33 is configured to configure a wireless device with a first frequency hopping distance that results in a resource allocation at two edges of a slot. The receiving module 77 is configured to receive transmission corresponding to a modified resource allocation that avoids the resource allocation at two edges of the slot, the modified resource allocation corresponding to a second frequency hopping distance different from the first frequency hopping distance.

FIG. 7 is a block diagram of an alternative wireless device 22, which may be implemented at least in part by software modules containing software executable by a processor to perform the functions described herein. The WD 22 includes a radio interface module 83 configured to set up and maintain a wireless connection 64 with a network node 16 serving a coverage area 18 in which the WD 22 is currently located. The memory module 89 is configured to store data, programmatic software code and/or other information described herein. The modification module 35 is configured to, if a configured frequency hopping distance results in a resource allocation at two edges of a slot, apply a modified resource allocation that avoids resource allocation at two edges of the slot where the modified resource allocation corresponds to a frequency hopping distance different from the configured frequency hopping distance. The transmission module 95 is configured to transmit using the modified resource allocation.

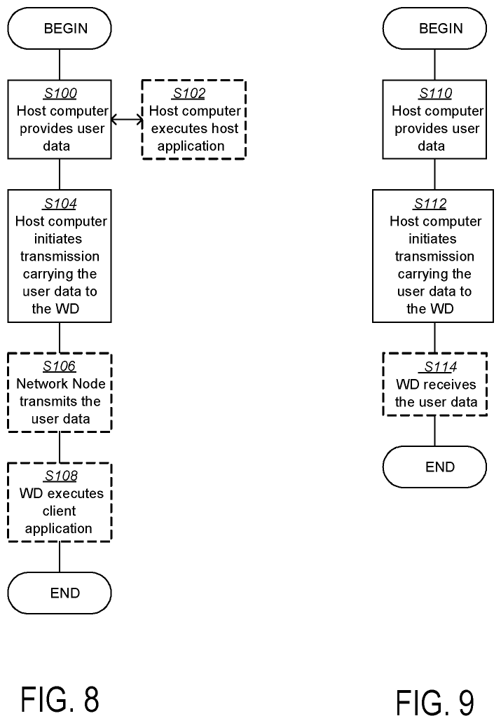

FIG. 8 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104). In an optional third step, the network node 16 transmits to the WD 22 the user data which was carried in the transmission that the host computer 22 initiated, in accordance with the teachings of the embodiments described throughout this disclosure (block S106). In an optional fourth step, the WD 22 executes a client application, such as, for example, the client application 114, associated with the host application 74 executed by the host computer 24 (block S108).

FIG. 9 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (block S110). In an optional substep (not shown) the host computer 24 provides the user data by executing a host application, such as, for example, the host application 74. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

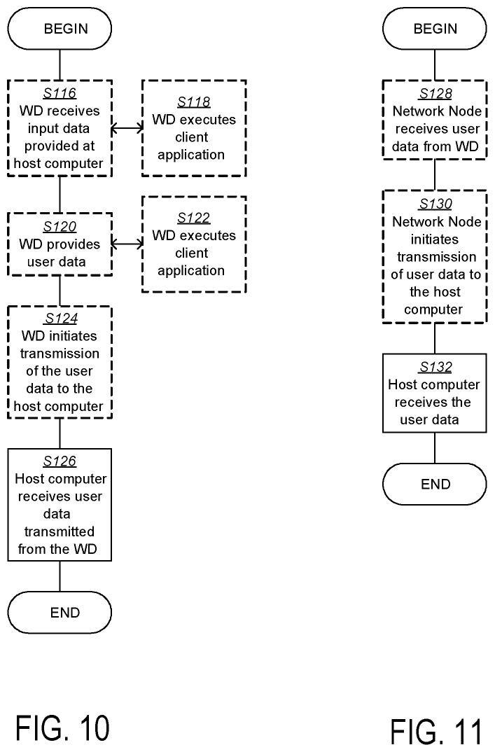

FIG. 10 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 11 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

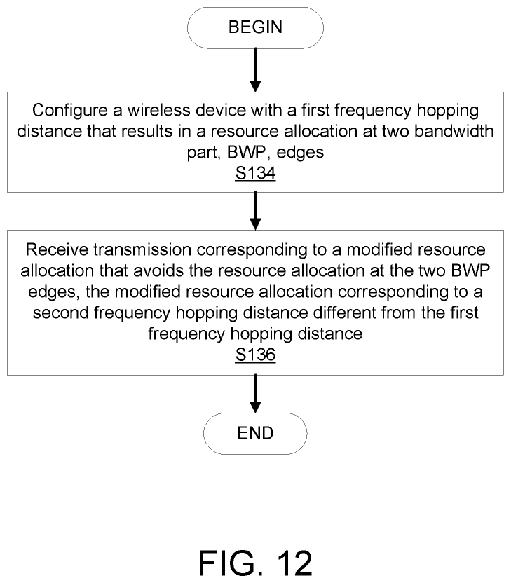

FIG. 12 is a flowchart of an exemplary process in a network node 16 for configuring WD 22 for transmission. One or more Blocks and/or functions and/or methods performed by the network node 16 may be performed by one or more elements of network node 16 such as by configuration unit 32 and/or receiving unit 76 in processing circuitry 68, processor 70, radio interface 62, etc. In one embodiment, the exemplary method includes configuring (block S134), such as via configuration unit 32, a wireless device, WD 22, with a first frequency hopping distance that results in a resource allocation at two bandwidth part, BWP, edges. The method includes receiving (block S136), such as via radio interface 62 and/or receiving unit 76, a transmission corresponding to a modified resource allocation that avoids the resource allocation at the two BWP edges, the modified resource allocation corresponding to a second frequency hopping distance different from the first frequency hopping distance.

In some embodiments, the two BWP edges are BWP edges of a slot (or other time resource). In some embodiments, the resource allocation at the two BWP edges corresponds to a partial wrap around of resources. In some embodiments, the modified resource allocation corresponds to at least at least one of: a frequency hopping distance that is one of shorter and longer than the configured first frequency hopping distance; and a resource allocation at one BWP edge of the two BWP edges. In some embodiments, the two BWP edges are two BWP edges of a slot (or other time resource) and the modified resource allocation corresponds to at least one of: a resource allocation of another slot preceding the slot; a mirroring of the resource allocation of another slot preceding the slot; and a frequency hopping distance that is equal to a negative value of the configured first frequency hopping distance. In some embodiments, the modified resource allocation corresponds to a discontinuous transmission.

In another embodiment, processing circuitry 68 is configured to configure a wireless device with a first frequency hopping distance that results in a resource allocation at two edges of a slot, as described herein. Processing circuitry 68 is configured to receive transmission corresponding to a modified resource allocation that avoids the resource allocation at two edges of the slot where the modified resource allocation corresponds to a second frequency hopping distance different from the first frequency hopping distance. As used herein, “resource allocation at two edges of a slot” and/or “resource allocation at two BWP edges” may refer to a partial wrap around of resources, as described herein.

In one or more embodiments, the modified resource allocation: corresponds to a frequency hopping distance that is shorter than the configured frequency hopping distance, or corresponds to a resource allocation at one edge of the slot. In one or more embodiments, the modified resource allocation corresponds to: a resource allocation of another slot preceding the slot, a mirroring of the resource allocation of another slot preceding the slot, or a frequency hopping distance that is equal to a negative value of the configured frequency hopping distance.

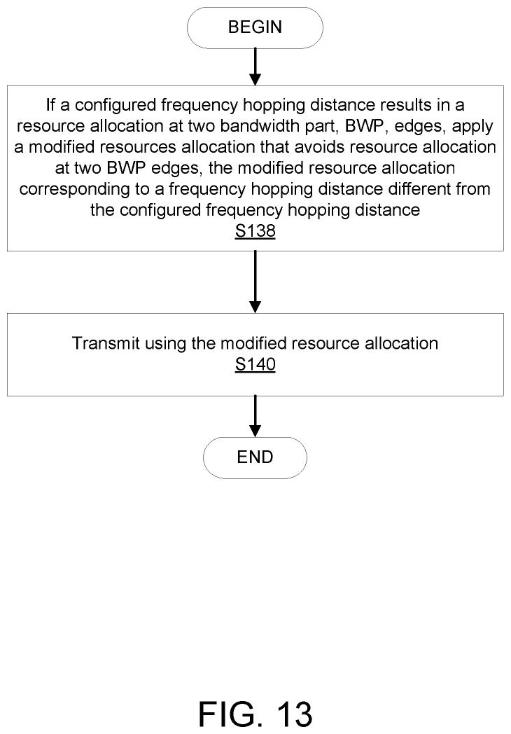

FIG. 13 is a flowchart of an exemplary process in a wireless device 22 for modifying resource allocation according to some embodiments of the present disclosure. One or more Blocks and/or functions and/or methods performed by WD 22 may be performed by one or more elements of WD 22 such as by modification unit 34 and/or transmission unit 94 in processing circuitry 84, processor 86, radio interface 82, etc. The exemplary method includes, if a configured frequency hopping distance results in a resource allocation at two bandwidth part, BWP, edges, applying (block S138), such as via modification unit 34, a modified resource allocation that avoids resource allocation at two BWP edges, the modified resource allocation corresponding to a frequency hopping distance different from the configured frequency hopping distance. The exemplary method includes transmitting (block S140), such as via radio interface 82 and/or transmission unit 94, using the modified resource allocation.

In some embodiments, the two BWP edges are two BWP edges of a slot. In some embodiments, the resource allocation at the two BWP edges corresponds to a partial wrap around of resources. In some embodiments, the modified resource allocation corresponds to at least one of: a frequency hopping distance that is one of shorter and longer than the configured frequency hopping distance; and a resource allocation at one BWP edge of the two BWP edges. In some embodiments, the two BWP edges are two BWP edges of a slot and the modified resource allocation corresponds to at least one of: a resource allocation of another slot preceding the slot; a mirroring of the resource allocation of another slot preceding the slot; and a frequency hopping distance that is equal to a negative value of the configured frequency hopping distance. In some embodiments, the modified resource allocation corresponds to a discontinuous transmission. In some embodiments, the method further includes one of applying the modified resource allocation and applying, such as via modification unit 34, the configured frequency hopping distance based on a type of waveform.

In another embodiment, processing circuitry 84 is configured to, if a configured frequency hopping distance results in a resource allocation at two edges of a slot, apply a modified resource allocation that avoids resource allocation at two edges of the slot where the modified resource allocation corresponds to a frequency hopping distance different from the configured frequency hopping distance, as described herein. Processing circuitry 84 is configured to transmit using the modified resource allocation.

Embodiments provide uplink frequency hopping allocation in wireless communications. In one example, a modified resource allocation is applied in order to help avoid resource allocation at partly wrapped resources resource allocation at two edges of the slot, where the modified resources correspond to change in the frequency hopping distance. These embodiments are further described herein. Some of these embodiments are described in detail below.

In the following embodiments an assumption is made that the WD 22 obtains an original resource allocation (first resource allocation) to be used in a first time interval (1st frequency-hop). For a second time interval (2nd frequency-hop), the WD 22 determines the resource allocation (second resource allocation) based on the original resource allocation and a hopping distance.

Solution 1: Adopting the Hopping Distance

In this solution, the hopping distance between the first and second resource allocations is modified to ensure that the frequency-hopped resource allocation (second resource allocation) does not partly wrap around. In one or more embodiments, the frequency-hopped resource allocation (resources allocated for the second frequency hop) may correspond to a hop distance different from the originally configured hop distance, where the originally configured hop would have led to the partial wrap around. In one or more embodiments, complete wrap around may be acceptable as the resources are allocation on one towards one side of the slot. An example of solution 1 is illustrated in pseudo code as follows:

```
If no partial wrap around with original hopping distance
    Frequency-hop with original hopping distance
Else
    Frequency-hop with modified hopping distance
End
```

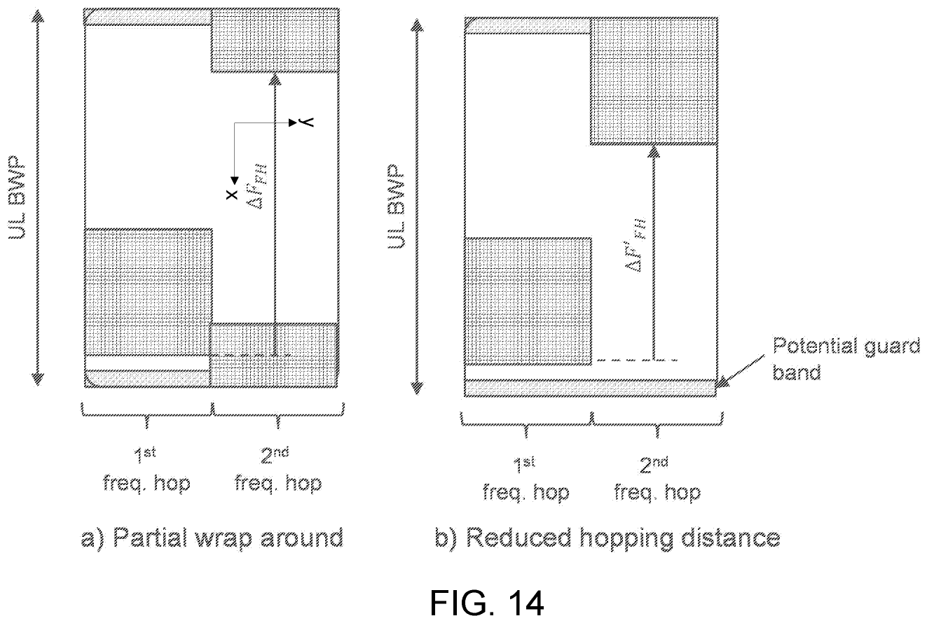

FIG. 14 is a diagram that shows how the hopping distance is modified to help ensure the resource allocation in the second slot (i.e., frequency-hopped resource allocation or second resource allocation) does not wrap around (i.e., second frequency hop in wraps around the slot in that resources are located on two separate “islands” at both edges of the slot). In particular, (a) in FIG. 14 illustrates the original hopping distance where the frequency-hopped resource allocation partly wraps around, and (b) in FIG. 14 illustrates where the original hopping distance is reduced to help ensure the frequency-hopped resource allocation does not wrap around, where, for example, the x-axis is the time axis and the y-axis is the frequency axis.

In this example, the hopping distance is reduced as shown in (b) of FIG. 14 when compared to (a) in FIG. 14. If the original hopping distance is determined to wrap a majority of the resource allocation around, then the hopping distance may be increased in order to completely wrap around the resource allocation. This embodiment where the hopping distance is increased is written in pseudo code as follows:

```
    If no partial wrap around with
    original hopping distance
      Frequency-hop with original hopping distance
    Else if partial wrap around occurs
    with original hopping
    distance, majority of
frequency-hopped resource allocation
does not wrap around
      Frequency-hop with reduced hopping
      distance to avoid wrap around
    Else
      Frequency-hop with increased hopping
      distance to force complete
wrap around (Note: an increased hopping
distance can also be modeled with a sign-
reversed and potentially modified
original hopping distance)
    End
```

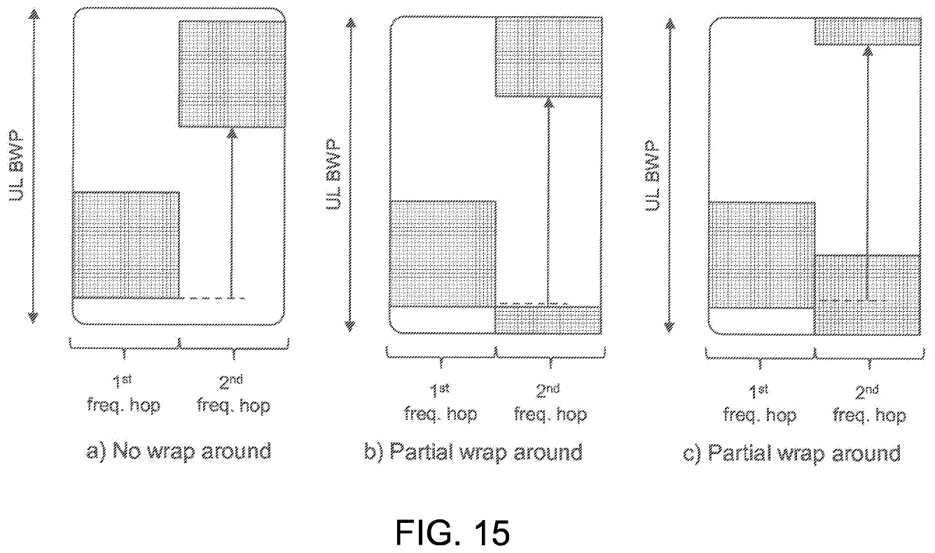

In one or more embodiments, guard bands at the edges within a BWP (either on one or both edges) can be introduced as shown in FIG. 14. The wrap around and re-enter of resources in the second slot may occur at the inner edges of the guard bands (not shown in FIG. 14). FIG. 15 is a diagram of different examples of resource allocations without wrap around, and resource allocations with wrap around, where the majority/minority of the resource allocation wraps around. In particular, (a) in FIG. 15 is a diagram where no wrap around occurs, (b) in FIG. 15 is a diagram where partial wrap around occurs in which a majority of the frequency-hopped resource allocation do not wrapping round, and (c) in FIG. 15 is a diagram where partial wrap around in which a majority of the frequency-hopped resource allocation wraps around (x-axis: time, y-axis: frequency).

Solution 2: No Frequency Hopping

In some embodiments, no frequency hopping is applied if partial wrap around is to occur, i.e., the same resource allocation is assumed for both frequency hops. For example, the resource allocation for the second slot/second frequency hop is the same as the first slot/first frequency hop. In one or more embodiments, the frequency-hopped resource allocation (resources allocated for the second frequency hop) may correspond to a hop distance different from the originally configured hop distance, where the originally configured hop would have led to the partial wrap around. An example of solution 2 is written in pseudo code as:

```
If no partial wrap around with original hopping distance
    Frequency-hop with original hopping distance
Else
    Don't hop, i.e. assume same resource allocation
End
```

Solution 3: Mirroring

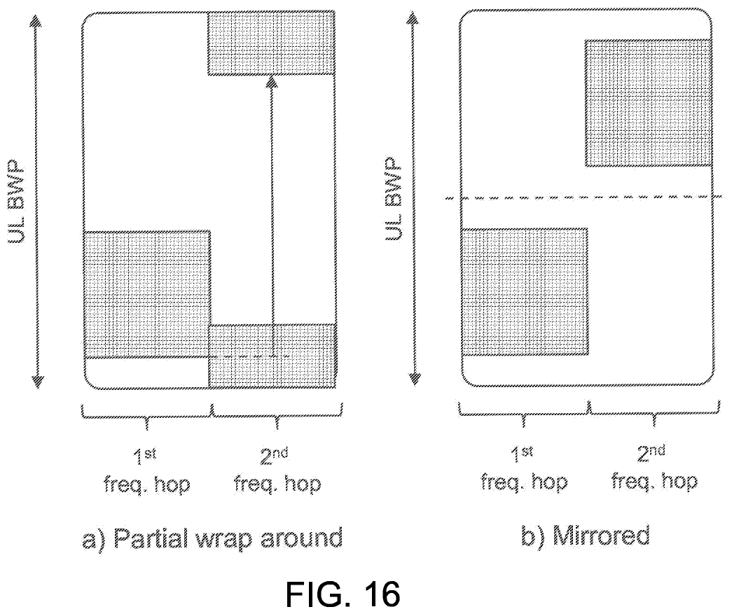

In some embodiments, the frequency-hopped resource allocation (i.e., the second frequency hop) is determined based on mirroring of the original resource allocation (i.e., mirroring of the first frequency hop) in case a partial wrap around may occur when applying the hopping distance. An example of Solution 3 is illustrated in FIG. 16, where (a) in FIG. 16 illustrates the original hopping distance where the frequency-hopped resource allocation partly wraps around, and (b) in FIG. 16 illustrates where the frequency-hopped resource allocation is determined based on mirroring of the original resource allocation, if hopping with the original hopping distance would lead to a partial wraparound (x-axis: time, y-axis: frequency). In one or more embodiments, the frequency-hopped resource allocation (resources allocated for the second frequency hop) may correspond to a hop distance different from the originally configured hop distance, where the originally configured hop would have led to the partial wrap around.

Solution 4: Sign Reversal

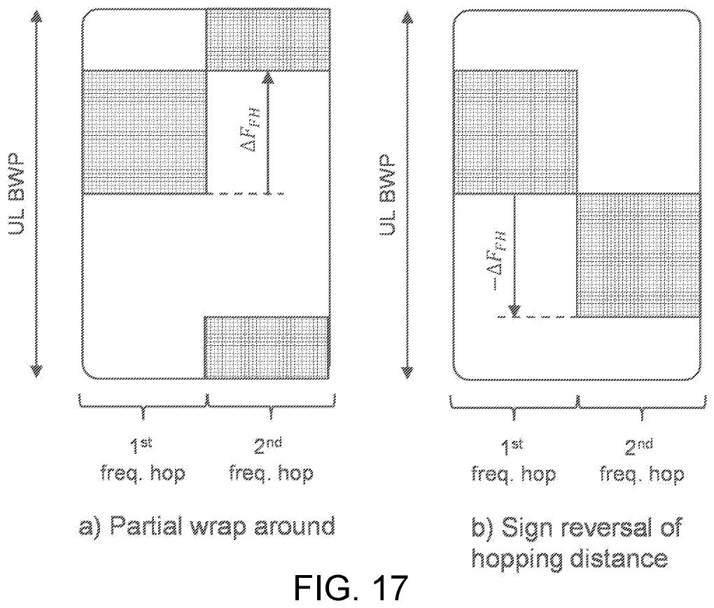

In case the frequency-hopped resource allocation is partially wrapped around in the second slot/second frequency hop, the hopping direction of the second frequency hop may be reversed, in some embodiments. If this resource allocation with a reversed hopping direction leads to a partial wrap around, Solution 4 may be combined with Solutions 3 and/or 2. FIG. 17 is a diagram of an example of Solution 4 where (a) in FIG. 17 illustrates the original hopping distance where the frequency-hopped resource allocation partly wraps around, and (b) in FIG. 17 illustrates the frequency-hopping distance where the sign is reversed (reverse hopping direction hopping amount, i.e., hop forward in frequency of 4 resources may become “−4” or a hop backwards in time of 4 resources) in case the original hopping would lead to a partial wrap around. In one or more embodiments, the frequency-hopped resource allocation (resources allocated for the second frequency hop) may correspond to a hop distance different from the originally configured hop distance, where the originally configured hop would have led to the partial wrap around.

Solution 5: Discontinuous Transmission (DTX)

In some embodiments, if a frequency-hopped resource allocation of the second frequency hop results in a partial wrap around, the WD 22 may not transmit using the frequency-hopped resource allocation. Typically, the WD 22 may not transmit during the time duration where the original (first frequency hop) resource allocation is valid, i.e., the WD 22 would consider this an “illegal” scheduling grant and may not following the grant.

Solution 6: Implementation Specific

In some embodiments, the network node 16 can configure multiple hopping offsets. One of the configured hopping offsets may be 0 such that the “frequency-hopped” resource allocation (with hopping distance 0) may always stay within the BWP, irrespective of the original resource allocation.

One or more of the above solutions could be dependent on the waveform. If a partial wrap around occurs, one of the above solutions is applied if the waveform is a low PAPR waveform such as DFTS-OFDM. In case the waveform has a high PAPR such as in multicarrier or OFDM, the resource allocation with the partial wrap around may be used.

One or more solutions presented above may help to avoid the frequency-hopped resource allocation being partly wrapped around a BWP, i.e., some parts of the resources would be at a lower edge of the BWP while some parts of the resources would be at the upper edge of the BWP. This partial wrap around of resources may also correspond to resource allocation at two edges of a slot, and/or two BWP edges of a time resource such as a slot, as illustrated, for example, in FIG. 16a.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

### BWP Bandwidth Part

### DCI Downlink Control Information

### DFTS-OFDM Discrete Fourier Transform Spread OFDM

### PAPR Peak to Average Power Ratio

### PRB Physical Resource Block

### RRC Radio Resource Control

### VRB Virtual Resource Block

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device, WD, configured to communicate with a network node, the WD comprising a radio interface and processing circuitry configured to:
if a configured frequency hopping distance results in a resource allocation at two bandwidth part, BWP, edges, apply a modified resource allocation that avoids resource allocation at two BWP edges, the modified resource allocation corresponding to a frequency hopping distance different from the configured frequency hopping distance; and
transmit using the modified resource allocation.

2. The WD of claim 1, wherein the two BWP edges are two BWP edges of a slot.

3. The WD of claim 1, wherein the resource allocation at the two BWP edges corresponds to a partial wrap around of resources.

4. The WD of claim 1, wherein the modified resource allocation corresponds to at least one of:
a frequency hopping distance that is one of shorter and longer than the configured frequency hopping distance; and
a resource allocation at one BWP edge of the two BWP edges.

5. The WD of claim 1, wherein the two BWP edges are two BWP edges of a slot and the modified resource allocation corresponds to at least one of:
a resource allocation of another slot preceding the slot;
a mirroring of the resource allocation of another slot preceding the slot; and
a frequency hopping distance that is equal to a negative value of the configured frequency hopping distance.

6. The WD of claim 1, wherein the modified resource allocation corresponds to a discontinuous transmission.

7. The WD of claim 1, wherein the processing circuitry is configured to one of apply the modified resource allocation and apply the configured frequency hopping distance based on a type of waveform.

8. A method implemented in a wireless device, WD, the method comprising:
if a configured frequency hopping distance results in a resource allocation at two bandwidth part, BWP, edges, applying a modified resource allocation that avoids resource allocation at two BWP edges, the modified resource allocation corresponding to a frequency hopping distance different from the configured frequency hopping distance; and
transmitting using the modified resource allocation.

9. The method of claim 8, wherein the two BWP edges are two BWP edges of a slot.

10. The method of claim 8, wherein the resource allocation at the two BWP edges corresponds to a partial wrap around of resources.

11. The method of claim 8, wherein the modified resource allocation corresponds to at least one of:
a frequency hopping distance that is one of shorter and longer than the configured frequency hopping distance; and
a resource allocation at one BWP edge of the two BWP edges.

12. The method of claim 8, wherein the two BWP edges are two BWP edges of a slot and the modified resource allocation corresponds to at least one of:
a resource allocation of another slot preceding the slot;
a mirroring of the resource allocation of another slot preceding the slot; and
a frequency hopping distance that is equal to a negative value of the configured frequency hopping distance.

13. The method of claim 8, wherein the modified resource allocation corresponds to a discontinuous transmission.

14. The method of claim 8, further comprising one of applying the modified resource allocation and applying the configured frequency hopping distance based on a type of waveform.

15. A network node comprising a radio interface and processing circuitry configured to:
configure a wireless device, WD, with a first frequency hopping distance that results in a resource allocation at two bandwidth part, BWP, edges; and
receive a transmission corresponding to a modified resource allocation that avoids the resource allocation at the two BWP edges, the modified resource allocation corresponding to a second frequency hopping distance different from the first frequency hopping distance.

16. The network node of claim 15, wherein the two BWP edges are BWP edges of a slot.

17. The network node of claim 15, wherein the resource allocation at the two BWP edges corresponds to a partial wrap around of resources.

18. The network node of claim 15, wherein the modified resource allocation corresponds to at least at least one of:
a frequency hopping distance that is one of shorter and longer than the configured first frequency hopping distance; and
a resource allocation at one BWP edge of the two BWP edges.

19. The network node of claim 15, wherein the two BWP edges are two BWP edges of a slot and the modified resource allocation corresponds to at least one of:
a resource allocation of another slot preceding the slot;
a mirroring of the resource allocation of another slot preceding the slot; and
a frequency hopping distance that is equal to a negative value of the configured first frequency hopping distance.

20. The network node of claim 15, wherein the modified resource allocation corresponds to a discontinuous transmission.

21. A method implemented in a network node, the method comprising:
configuring a wireless device, WD, with a first frequency hopping distance that results in a resource allocation at two bandwidth part, BWP, edges; and
receiving a transmission corresponding to a modified resource allocation that avoids the resource allocation at the two BWP edges, the modified resource allocation corresponding to a second frequency hopping distance different from the first frequency hopping distance.

22. The method of claim 21, wherein the two BWP edges are BWP edges of a slot.

23. The method of claim 21, wherein the resource allocation at the two BWP edges corresponds to a partial wrap around of resources.

24. The method of claim 21, wherein the modified resource allocation corresponds to at least at least one of:
a frequency hopping distance that is one of shorter and longer than the configured first frequency hopping distance; and
a resource allocation at one BWP edge of the two BWP edges.

25. The method of claim 21, wherein the two BWP edges are two BWP edges of a slot and the modified resource allocation corresponds to at least one of:
a resource allocation of another slot preceding the slot;
a mirroring of the resource allocation of another slot preceding the slot; and
a frequency hopping distance that is equal to a negative value of the configured first frequency hopping distance.

26. The method of claim 21, wherein the modified resource allocation corresponds to a discontinuous transmission.
